(19) United States
(12) Patent Application Publication
(10) Pub. No.: US 2025/0214361 A1
(43) Pub. Date: Jul. 3, 2025

(54) Vehicle Component, Motor Vehicle With a Vehicle Component and Method for Producing a Vehicle Component

(71) Applicant: Bayerische Motoren Werke Aktiengesellschaft, Muenchen (DE)

(72) Inventors: Matthias NAGEL, Lenggries (DE); Martin SCHNEEBAUER, Muenchen (DE)

(21) Appl. No.: 18/852,594

(22) PCT Filed: May 26, 2023
(86) PCT No.: PCT/EP2023/064193

§ 371 Date: Sep. 30, 2024

(30) Foreign Application Priority Data
Jul. 13, 2022 (DE) 10 2022 117 497.2

(51) Int. Cl. B41M 5/26; B29C 45/00; B29K 23/00; B29L 31/30

(52) U.S. Cl. CPC B41M 5/267; B29C 45/0055; B29K 2023/12; B29L 2031/3041

(57) ABSTRACT

A vehicle component for a motor vehicle with a moulding made of a polymer compound which contains laser-sensitive pigments and in which some of the laser-sensitive pigments are altered by irradiation with high-energy radiation, such that the irradiated laser-sensitive pigments undergo a change in colour in comparison with the non-irradiated laser-sensitive pigments. The irradiation with high-energy radiation takes place in such a way that the surface of the moulding has a stone patterning or terrazzo-like patterning. A motor vehicle with such a vehicle component and a production method are also specified.

### BACKGROUND AND SUMMARY

This disclosure relates to a vehicle component, to a motor vehicle having such a vehicle component, and to a method of producing such a vehicle component.

Sustainable motor vehicles are a topic of intense interest in the vehicle industry. There have already been a variety of efforts to act sustainably in the production of vehicles, and hence to save energy and raw materials and conserve the environment.

Large plastic installable components for premium applications are usually painted. For example, painted bumper claddings made of plastic are customary nowadays, and these achieve the desired look (for example color and color effects) and/or surface protection via single- or multicoat painting. However, painting is inconvenient and costly and causes a large CO2 footprint in the component. Furthermore, specifically, in the lower viewing region of the vehicle exterior, there are unpainted plastic components having surface grain, for example, door sills.

In the premium segment, customers desire a particularly high-quality look of the surfaces. The use here of multiphase compounds with a masterbatch and color(s) quickly reaches processing limits that restrict the optical effects achievable to a high degree.

It is known from vehicle interiors that relatively small components, for example switches, can be marked with a symbol or lettering by laser marking. In this case, previously applied paint layers, varnish layers, and outer layers are partly removed, which makes the base material visible again.

In addition, document DE 102 52 007 A1 discloses laser-markable pigments that can be incorporated into polymer compounds. By irradiation with laser radiation, the shade of the laser-markable pigments is modified and a deep black marking is created.

Against this background, it is an object of the disclosure to specify a way of sustainable production of a vehicle component that offers a variety of design options. In a further aspect, the surface is to have a particularly high-quality look.

A vehicle component for a motor vehicle is specified, having a shaped body formed from a polymer compound including laser-sensitive pigments, and in which a portion of the laser-sensitive pigments has been modified by irradiation with high-energy radiation such that the irradiated laser-sensitive pigments have a color change compared to the non-irradiated laser-sensitive pigments. The irradiation with high-energy radiation is effected here such that the surface of the polymer compound has a stone pattern or terrazzo-like pattern.

In the vehicle component of the disclosure, a high-quality look is combined with high sustainability. The stone pattern or terrazzo-like pattern is regarded as being of particularly high quality by customers. The vehicle component of the disclosure now makes it possible for the first time to create these patterns without use of paint layers-in particular colored paints. It is thus possible to save on energy costs, and the vehicle component contains fewer different materials, which increases recyclability. The creation of patterns by way of laser-sensitive pigments is additionally virtually emission-free. Moreover, the coloring of the material itself reduces proneness to damage. This means that exchange or repair for visual reasons is less commonly necessary. All this together brings about elevated sustainability of the vehicle component.

A stone pattern in the context of this application shall be considered to mean a pattern similar to the texture of natural stone. A stone pattern is associated by the observer with a stone surface and can even create the perception of a stone surface. The stone pattern may especially have a marble look.

Terrazzo is a flooring material with centuries of tradition that nowadays represents elegance. Terrazzo flooring is typically characterized by a dominant main color incorporating small areas (for example of fingernail size) of a different color. The different-colored areas may all be formed in one color, or it is possible to combine multiple color areas of different color. In this respect, a terrazzo-like pattern means a pattern which is associated by the observer with a terrazzo floor or even creates the perception of a terrazzo floor.

The laser-sensitive pigments are pigments that change color under irradiation with high-energy radiation. The laser-sensitive pigments may be in powder form or in pellet form. Powder pigments react under the influence of the high-energy radiation by carbonization, which forms carbon black and causes the material to become gray to black in color. Alternatively, it is the carbon in the pigments that reacts, forming CO2, which results in tiny bubbles that make the material light-colored to white. Pelletized pigments include absorbents and color formers. Under the influence of high-energy radiation, the absorbents absorb the radiation and activate or stimulate the color formers. In this way, it is possible to form colored markings that may include, for example, orange, red or blue shades. In all cases, the color of the pigment changes from the original color to a different final color, which is referred to in the context of this application as color change. Laser-sensitive pigments can be sourced under the Merck Iriotech trade name among others.

The polymer compound comprises at least one polymer that has additionally been admixed with fillers, stabilizers (UV stabilizers or others), reinforcers and/or other additives. Compounding modifies the properties of the polymers for the respective application. The polymer compound is preferably UV-resistant. The polymer compound is more preferably based on impact-modified and talc-reinforced polypropylene, which qualifies it in particular for use in an installable exterior component.

In one configuration, sustainability of the vehicle component is enhanced in that the polymer compound is based on a non-mineral oil-based plastic or includes a non-mineral oil-based plastic. Such plastics can be obtained, for example, from vegetable oils or fats.

In a preferred configuration, sustainability of the vehicle component is enhanced in that the polymer compound comprises recycled polymer material. The recycled polymer material is obtained from polymer wastes and is processed to recyclate, for example in pellet form. This recyclate is then added proportionately in the production of the polymer compound, where the proportion may be varied depending on the requirements. The preferred proportion of recyclate is between 20-70% (by weight). The polymer compound in that case includes both virgin polymer and recycled polymer. For example, it is possible to include post-consumer recyclate, for example plastic from used vehicles, in the new production of vehicles.

The stone pattern or terrazzo-like pattern of the shaped body makes it possible to dispense with a protective outer layer on the shaped body. The visible surface is that surface of the vehicle component which is visible to a user or observer of the vehicle. By virtue of the irradiation with high-energy radiation, the stone pattern or terrazzo-like pattern is created not just superficially but also up to a certain depth of the shaped body. As a result, relatively minor damage to the surface, for example scratches, does not alter the pattern and hence is barely apparent to the observer. In particular, it is therefore possible in one configuration to dispense with a clearcoat layer or PUR (i.e., polyurethane) outer layer and for a surface of the shaped body to form a visible surface of the vehicle component which is free of outer layers.

For further reduction of the visibility of relatively minor surface damage, it may be the case in one configuration that the visible surface of the vehicle component is grained. The grain is preferably created directly in the production of the shaped body, for example by way of a grained surface in the injection mold.

In one embodiment, the shaped body has a black main color and the irradiated laser-sensitive particles create a white, gray and/or colored pattern in the black main color.

It is particularly preferable when the surface pattern created by the color change extends over the entire visible surface of the vehicle component. This achieves a uniform appearance that gives the impression that the whole vehicle component is formed from stone.

The vehicle component is preferably an exterior component. In particular, the vehicle component may be an installable exterior component, for example a bumper cladding, an insert in a bumper cladding, a diffuser plate or a sill cladding.

Additionally specified is a motor vehicle having an above-described vehicle component. The use of one or more of the vehicle components of the disclosure in a motor vehicle achieves the described technical advantages for the motor vehicle as well. In particular, it is possible to increase sustainability in vehicle production and at the same time to achieve a high-quality look of the vehicle.

In a further aspect, a method of producing a vehicle component is specified. The method includes the steps of:
producing a shaped body from a polymer compound including laser-sensitive pigments, and
irradiating a portion of the laser-sensitive pigments with high-energy radiation such that the irradiated pigments undergo a color change by comparison with the non-irradiated laser-sensitive pigments, and the surface of the polymer compound after the irradiation has a stone pattern or terrazzo-like pattern.

For the production of the shaped body, the polymer compound is first produced, for which the required constituents are mixed together. The polymer compound is then formed, for example in an injection molding method, to the shaped body while hot. The shaped body has a three-dimensional shape and preferably essentially defines the geometric dimensions of the vehicle component.

The laser-sensitive pigments are irradiated with high-energy radiation, generally in the wavelength range from 157 nm to 10 600 nm. This is preferably provided by way of a laser, for example a CO2 laser, a Nd:YAG laser or an excimer laser, directed onto the surface of the shaped body and guided over the surface to produce the desired pattern. The radiation power and the exposure time are chosen here depending on the desired color change. The laser beam may be guided over the component, for example, according to a pattern and activated whenever particles are to be exposed. A great advantage here is the flexibility of the method to create new designs of vehicle components, especially in the exterior. This is directly possible by varying the laser pattern. A change is even possible online as the process is running, which means that JIT (just in time) manufacture or JIS (just in sequence) manufacture is possible without difficulty. It is possible thereby to implement individual customer wishes with regard to the surface pattern without having to use additional resources.

Features and details described in connection with the vehicle component are also applicable in connection with the method of the disclosure, and vice versa in each case, such that, with regard to the disclosure of the individual aspects of the disclosure, reference is always or may always be made reciprocally.

Further advantages, features and details of the disclosure will be apparent from the description that follows, in which working examples of the disclosure are described specifically with reference to the drawings. The features mentioned here in the claims and in the description may each be essential to the disclosure individually or in any combination. Where the word “may” is used in this application, this means both the technical possibility and actual technical implementation.

### BRIEF DESCRIPTION OF THE DRAWINGS

Working examples are illustrated hereinafter with reference to the appended drawings.

FIGS. 1 to 3 show an illustrative motor vehicle with illustrative vehicle components;

FIG. 4 shows an illustrative diagram of a stone pattern;

FIG. 5 shows a section view of a shaped body of an illustrative vehicle component;

FIG. 6 shows an illustrative diagram of a terrazzo-like pattern; and,

FIGS. 7 to 9 show a further illustrative motor vehicle with illustrative vehicle components.

### DETAILED DESCRIPTION OF THE DRAWINGS

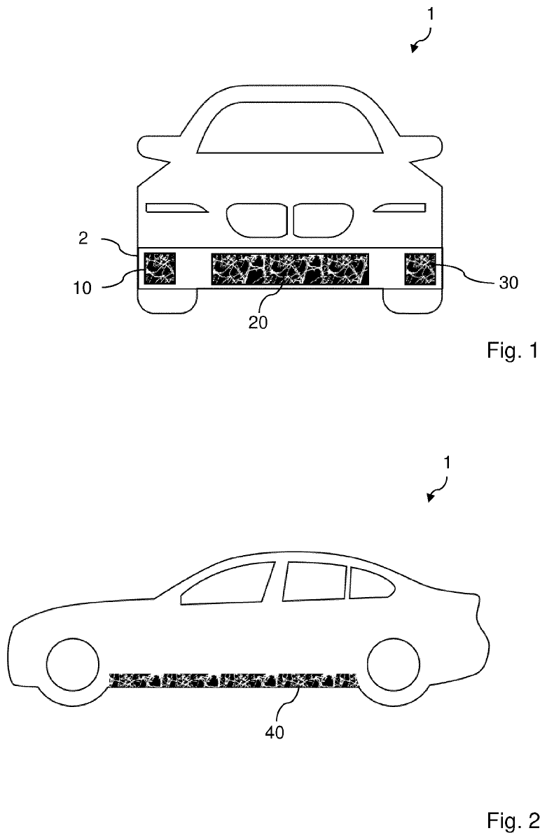

FIG. 1 shows an illustrative motor vehicle 1 in a front view with three illustrative vehicle components 10, 20, 30 in the form of inserts in a front bumper cladding 2. FIGS. 2 and 3 show further vehicle components 40 and 50 on the vehicle 1. Vehicle component 40 is a side skirt cladding; vehicle component 50 is a diffuser plate.

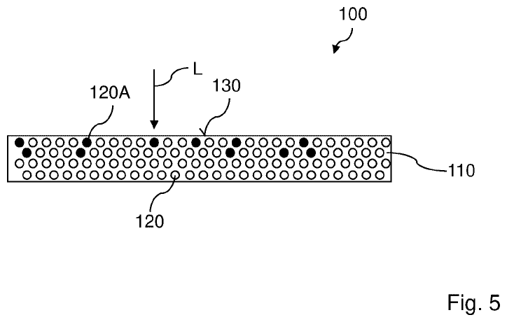

Vehicle components 10 to 50 each have a shaped body 100 which determines the main geometric outside dimensions of the vehicle component 10, 20, 30, 40 or 50 and which is formed from a polymer compound 110. The shaped body is described hereinafter with reference to FIG. 5. The polymer compound 110 is preferably based on impact-modified and talc-reinforced polypropylene to which, as well as further additives, a defined proportion of recycled polymer has been added. As well as other additives (not described), the polymer compound 110 includes additions of laser-sensitive pigments 120. First of all, the shaped body 100 is formed from the polymer compound 110, for example by injection molding. The shaped body may already have been provided here with a grain on its outer surface 130. This is followed by irradiation with high-energy radiation L, preferably by a laser, in defined regions with defined power and exposure time, which activates the laser-sensitive pigments in regions and results in a color change (the irradiated laser-sensitive pigments are labelled 120A). In the examples shown in FIGS. 1 to 3, the color change results in a stone pattern in a marble look.

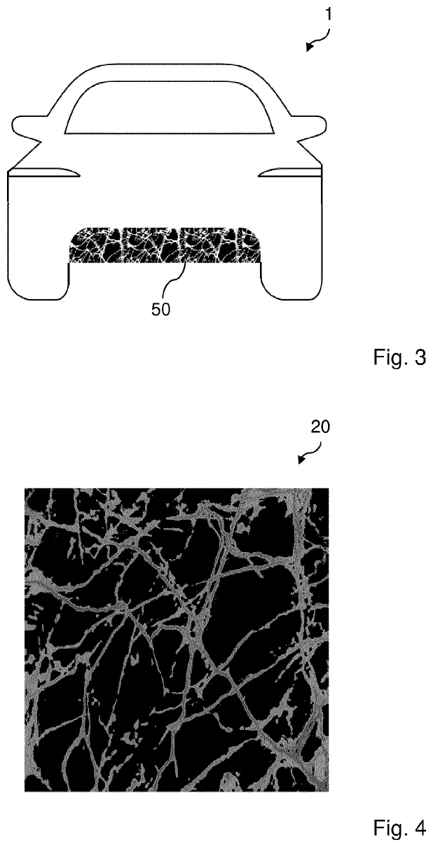

FIG. 4 shows, by way of example, a top view of an illustrative stone pattern 200. Irradiation with high-energy radiation L changes the color of the black polymer compound 110 to various gray shades in different regions. The high-energy radiation is steered across the surface so as to give rise to a marble surface which gives the impression of a marble slab.

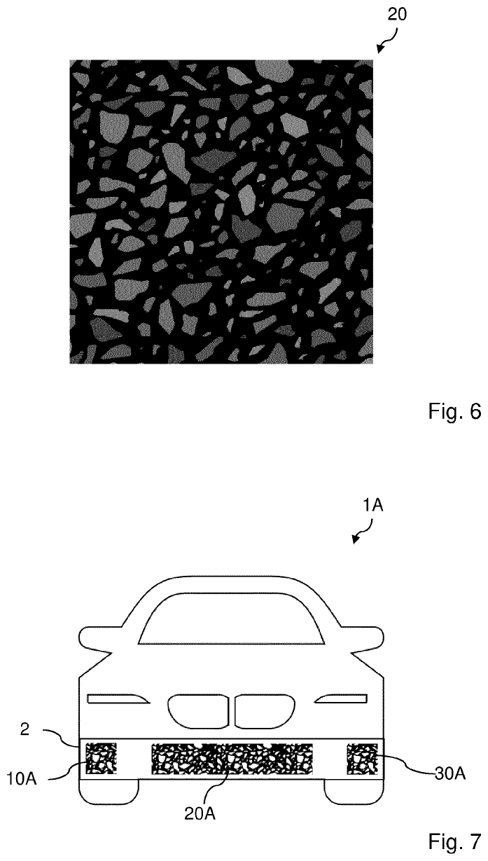

As well as a stone pattern, it is also possible to form a terrazzo-like pattern on the vehicle component. FIG. 6 shows a top view of a terrazzo-like pattern 300 for visualization thereof. This pattern is created by irradiating insular regions in the polymer compound with high-energy radiation of different power and exposure time. This forms spots with different gray shadowing in the otherwise black material. The overall look of the surface is reminiscent of the surface of a terrazzo floor covering.

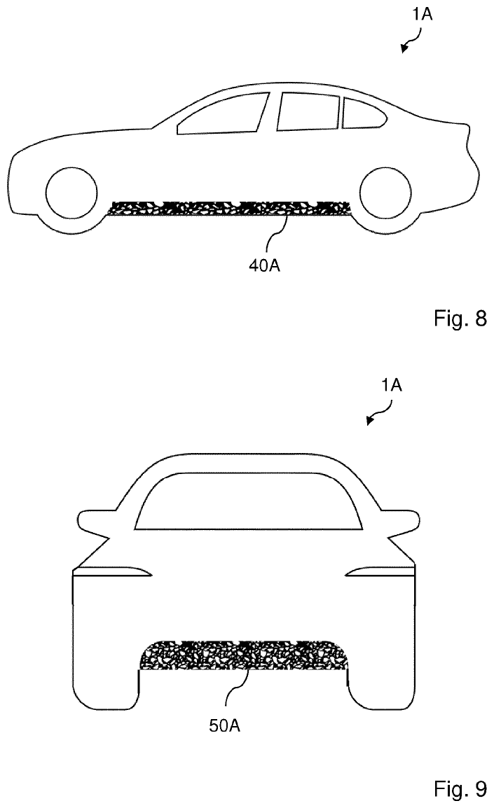

FIGS. 7 to 9 each show vehicle components 10A to 50A on a motor vehicle 1A with a terrazzo-like pattern. Vehicle component 10A differs from vehicle component 10 merely by the different pattern on the surface. The same applies to vehicle component 20A in relation to vehicle component 20, and also to 30A versus 30, 40A versus 40, and 50A versus 50. The remarks made with regard to FIG. 5 are equally applicable to vehicle components 10A to 50A.

Vehicle components 10 to 50 and 10A to 50A that are shown in the figures preferably do not have an outer layer on the shaped body. In this respect, the surface 130 of the shaped body 100 forms a visible surface of the vehicle component.

It will be apparent that the color change achievable by irradiation of the laser-sensitive pigments is not reduced to the gray shades described. It is equally possible by selection of suitable pigments and variation of the irradiation parameters to create white structures and/or colored structures, for example in orange, red and blue shades. It is likewise possible, rather than a black-colored polymer compound, also to use a different-colored compound.

### LIST OF REFERENCE NUMERALS

1, 1A motor vehicle
2 bumper cladding
10 to 50 vehicle component
10A to 50A vehicle component
100 shaped body
110 polymer compound
120 laser-sensitive pigments
120A irradiated laser-sensitive pigments
200 stone pattern
300 terrazzo-like pattern

1.-10. (canceled)

11. A vehicle component for a motor vehicle comprising:
a shaped body formed from a polymer compound including laser-sensitive pigments,
wherein a portion of the laser-sensitive pigments has been modified by irradiation with high-energy radiation such that the irradiated laser-sensitive pigments have a color change compared to the non-irradiated laser-sensitive pigments, and
wherein the irradiation with high-energy radiation is effected such that the surface of the shaped body has a stone pattern or terrazzo-like pattern.

12. The vehicle component according to claim 11, wherein
the polymer compound is based on a non-mineral oil-based plastic or includes a non-mineral oil-based plastic.

13. The vehicle component according to claim 11, wherein
the polymer compound includes recycled polymer material.

14. The vehicle component according to claim 11, wherein
the shaped body forms an outer layer-free visible surface of the vehicle component.

15. The vehicle component according to claim 14, wherein
the visible surface is grained.

16. The vehicle component according to claim 11, wherein
the shaped body has a black main color and the irradiated laser-sensitive particles create a white, gray and/or colored pattern in the black main color.

17. The vehicle component according to claim 11, wherein
the surface pattern created by the color change extends over the entire visible surface of the vehicle component.

18. The vehicle component according to claim 11, which is an exterior component.

19. A motor vehicle having a vehicle component according to claim 11.

20. A method of producing a vehicle component comprising:
producing a shaped body from a polymer compound including laser-sensitive pigments, and
irradiating a portion of the laser-sensitive pigments with high-energy radiation such that the irradiated laser-sensitive pigments undergo a color change by comparison with the non-irradiated laser-sensitive pigments, and the surface of the shaped body after the irradiation has a stone pattern or terrazzo-like pattern.

21. The method according to claim 20, wherein
the polymer compound is based on a non-mineral oil-based plastic or includes a non-mineral oil-based plastic.

22. The method according to claim 20, wherein
the polymer compound includes recycled polymer material.

23. The method according to claim 20, wherein
the shaped body forms an outer layer-free visible surface of the vehicle component.

24. The method according to claim 20, wherein
the visible surface is grained.

25. The method according to claim 20, wherein
the shaped body has a black main color and the irradiated laser-sensitive particles create a white, gray and/or colored pattern in the black main color.

26. The method according to claim 20, wherein
the surface pattern created by the color change extends over the entire visible surface of the vehicle component.
